(19) United States
(12) Patent Application Publication
(10) Pub. No.: US 2023/0006193 A1
(43) Pub. Date: Jan. 5, 2023

(54) POROUS METAL MATRIX COMPOSITE AND METHOD FOR PRODUCING THE SAME

(71) Applicants: Yi-Ren TZENG, Tainan City (TW); Sheng-Hsiang CHIANG, Tainan City (TW)

(72) Inventors: Yi-Ren TZENG, Tainan City (TW); Sheng-Hsiang CHIANG, Tainan City (TW)

(21) Appl. No.: 17/852,170

(22) Filed: Jun. 28, 2022

Related U.S. Application Data
(60) Provisional application No. 63/217,085, filed on Jun. 30, 2021.

(51) Int. Cl. H01M 4/22; H01M 4/62; H01M 4/04

(52) U.S. Cl. CPC H01M 4/22; H01M 4/62; H01M 4/0433

(57) ABSTRACT

The present disclosure discloses a porous metal matrix composite (MMC), wherein the porous MMC includes a metal material, a spacing material forming an interconnected structure and embedded in the metal material to form an interface between the metal material and the interconnected structure; and a first plurality of pores located at the interface.

### CROSS-REFERENCE TO RELATED APPLICATION AND CLAIM OF PRIORITY

The present disclosure claims the right of priority based on U.S. Patent Application Ser. No. 63/217,085, filed on Jun. 30, 2021, at the USPTO, the disclosure of which is incorporated herein in its entirety by reference.

### FIELD OF THE DISCLOSURE

The present disclosure is related to an porous composite and a method of manufacturing same. In particular, the present disclosure is related to a porous metal matrix composite and a method for manufacturing same.

### BACKGROUND OF THE DISCLOSURE

The storage of electric power is a key technique in electric power source management and in the usage of regenerating energy. The storage of electric power includes physical and chemical types. In consideration of the necessity of rapid electricity charging and discharging capability as well as high storage capacity, the electrochemical battery has become the first priority for the application of micro-grid energy storage.

In the field of electrochemical batteries, the well-developed hybrid lead-carbon battery, which is a combination of a conventional lead-acid battery and an asymmetrical super capacitor, provides a possible solution to implement an electric power storage device that is likely to achieve economic benefits. The super capacitor having a rapid charge and discharge capability and combined with the conventional lead-acid battery can inhibit the occurrence of a sulfurization reaction on the negative electrode (e.g. a lead plate electrode) of the battery during the high rate partial stage of charge (HRPSoC) process, which dramatically decreases the life time of the battery after each cycle of charging and discharging. The so-called sulfurization effect is that the solid metal lead (Pb₍ₛ₎) on the negative electrode reacts with the sulfite ion (HSO₄⁻_{(aq)}) in the sulfuric acid solution during the oxidation process, and is converted into non-conductive solid sulfuric lead (PbSO₄₍ₛ₎). During the period in deep discharge or in the HRPSoC process, lead sulfate, which is non-conductive, easily forms and crystallizes. As the non-conductive lead sulfate grains gradually cover the surface of the lead electrode, the reverse reduction reaction cannot reduce all lead sulfate into metal lead due to poor conductivity. Thus, the energy storage efficiency of the battery is reduced and battery cycle life is also shortened.

Currently, a method to improve the issue of sulfurization of the negative electrode is to add a carbon material to the lead electrode to increase the effective electrical contact area between the lead sulfate and the conductive carbon material. This method can increase the cycle life of lead-acid batteries. However, without undergoing special high pressure (about 400 MPa) and high temperature (about 950° C.) treatment to form chemical bonds at the carbon-lead interface, the contact between the carbon materials and the lead electrode is only physically rather than chemically bonded, so the structure of the carbon modified electrode in the general process is quite loose. That is to say, the structural strength of the lead electrode decreases with the increase in the amount of carbon material added, so there is a certain limit to the addition ratio of the carbon material.

In addition, in the manufacture of such a hybrid type lead-carbon battery, a lead battery paste on a negative electrode of a conventional lead-acid battery is replaced partly or completely with a carbon material capacitor paste having a high specific area porosity. That is to say, the production of the hybrid lead-carbon battery can be completed through a highly industrialized conventional lead-acid battery manufacturing process, so it has the added benefit of low production costs. Moreover, the lead-acid battery itself has the properties of extremely high stability (or low maintenance cost) and high cyclic charge/discharge efficiency (above 75%). Therefore, this kind of hybrid lead-carbon battery can be used as an energy storage device of the micro grid class and for the lowest cost.

Although the combination of the conventional lead-acid battery and the asymmetric super capacitor can provide low-cost power storage, the high self-discharge rate and low cycle life of the battery at deep depth of discharge (DoD>50%) limit the wide application of the conventional hybrid type lead-carbon battery. The reason for the low cycle life at deep DoD is that two materials, i.e. a carbon material and a lead plate, present on the negative electrode plate are unable to bond to each other and cause the phenomena such as electrode interface corrosion and the like that easily occur on the lead-carbon interface. The reason for the high self-discharge rate is that porous carbon material with high surface area acts as an electrolyte super-capacitor storing charges and excess concentration of ions across the electric double layer. Those excess concentration of ions diffuse away and charges leak through the super-capacitor circuit when uncharged.

Therefore, a method that can effectively bond carbon material to lead material and form a porous structure of lead matrix with balanced super-capacitor effect is very important for the preparation of an electrode for the hybrid lead-carbon battery. In other words, it is a very important step on the way to achieving the goals of mass production and development of the porous hybrid lead-carbon battery with long cycle life at deep DoD.

In prior art, although the bonding problem between the lead and carbon materials can be solved by using coupling agents such as the precious metal, e.g. titanium, palladium, and platinum, or their oxides, these precious metal coupling agents are quite expensive and are still not beneficial to electrode production.

Therefore, the Applicant has disclosed a method for forming a lead-based porous substrate containing continuously interconnected lead-carbon interface layer to improve the problems of the prior art mentioned above. In addition, the Applicant has disclosed a porous metal matrix composite (MMC) having the lead-carbon interface layer and pores along the interface, and a method for producing the same.

### SUMMARY OF THE DISCLOSURE

In accordance with one aspect of the present disclosure, a method for producing a porous metal matrix composite (MMC) is provided. The method comprises the following steps: providing and stacking a first metal material and a layer including a plurality of spacing materials to form a stack; pressing the stack by applying a pressure; heating the stack under the pressure to melt a portion of the first metal material; cooling the stack to produce an MMC blank having a metal-spacing material interface; providing an electrolyte; and immersing the MMC blank into the electrolyte to form the porous MMC.

In accordance with another aspect of the present disclosure, a method for producing a porous metal matrix composite (MMC) is provided. The method comprises steps of providing a metal material; providing a spacing material forming an interconnected structure; embedding the spacing material in the metal material to form an interface between the metal material and the interconnected structure; and forming a first plurality of pores located at the interface.

In accordance with a further aspect of the present disclosure, a porous metal matrix composite (MMC) is provided. The porous MMC comprises a metal material; a spacing material forming an interconnected structure and embedded in the metal material to form an interface between the metal material and the interconnected structure; and a first plurality of pores located at the interface.

The above objectives and advantages of the present disclosure will become more readily apparent to those ordinarily skilled in the art after reviewing the following detailed descriptions and accompanying drawings, in which:

### BRIEF DESCRIPTION OF THE DRAWINGS

FIG. 1 shows a natural property that lead and carbon contact;

FIG. 2 is a schematic diagram showing a cross section of a porous metal matrix composite according to an embodiment of the present invention;

FIG. 3 is a schematic diagram showing a part of a layer of a plurality of porous materials according to an embodiment of the present invention;

FIGS. 4-7 shows a flowchart of the methods for producing a porous MMC having a plurality of spacing materials embedded therein according to an embodiment of the present invention;

FIGS. 8A-8C show how the porous MMC is produced using a mold according to an embodiment of the present invention;

FIGS. 9A-9C are schematic cross-sections of the porous lead plate showing how the pores are generated and create the diffusion pathways in the lead plate according to an embodiment of the present invention;

FIGS. 10A-10C each shows a cross-section of a piece of an MMC blank 100 with a tubular carbon fiber 102 having a hollow core 103 embedded in a lead material 101 at different stages;

FIG. 11A is a diagram showing the capacitance (i.e., capacity to hold charge) curve of an electrode made of the porous lead plate according to the present invention during several charging and discharging cycles; and

FIG. 11B is a diagram showing the capacitance curve of an electrode made of a pure lead plate during several charging and discharging cycles.

### DETAILED DESCRIPTION OF THE EMBODIMENTS

The present disclosure will now be described more specifically with reference to the following embodiments. It is to be noted that the following descriptions of embodiments of the present disclosure are presented herein for the purposes of illustration and description only; they are not intended to be exhaustive or to be limited to the precise form disclosed.

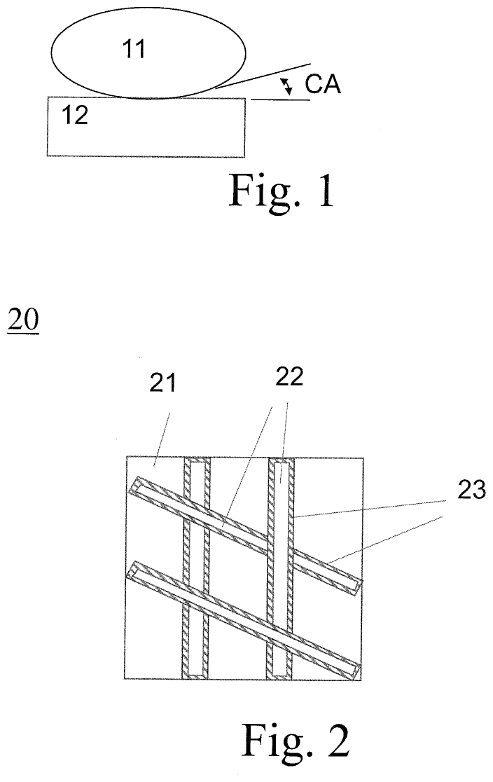

FIG. 1 shows a natural property that lead and carbon contact. Normally, trying to bond the lead material and the carbon material by a melted lead and a carbon material is very difficult. Because of the nature of lead and carbon, when a melted lead material 11 contacts the carbon material 12, as shown in FIG. 1, there will be a high contact angle CA between the melted lead material 11 and the carbon material 12. It means that the interacting force between these two materials is weak, so that it is hard to bond lead and carbon physically or chemically.

The present invention provides a feasible way to obtain a substrate having a chemically bonded lead-carbon interface. In addition, the present invention provides a feasible way to obtain a porous metal matrix composite having a lead-carbon interface.

One example of the porous metal matrix composite (MMC) is a porous lead plate having a carbon material embedded therein, or called a porous lead-carbon composite (LLC). A porous metal matrix composite having a lead-carbon interface made by the method according to the present invention can be applied to electrodes used in an acid battery including, but not limited to, a lead-acid battery. For example, the material for either one of the positive electrode (i.e. the cathode) and the negative electrode (i.e. the anode) can be a porous metal matrix composite.

FIG. 2 is a schematic diagram showing a cross section of a porous metal matrix composite 20. The porous MMC includes a metal material 21, a layer of plurality of spacing materials 22, pathways 23 along the interface of the metal material 21 and the spacing materials 22. The pathways 23 includes the pores that originally exist in the spacing materials, and the pores and passages generated because of erosion of the metal material 21 during the production process of the MMC. In an embodiment of the present invention, the porous MMC can be a porous lead carbon composite, the metal material is lead, and the plurality of spacing materials can be carbon fibers.

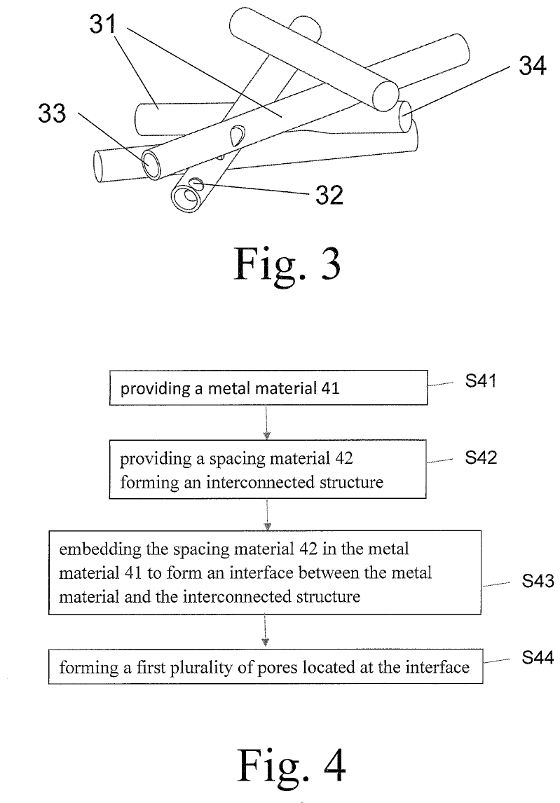

FIG. 3 is a schematic diagram showing a part of the layer of a plurality of spacing materials according to an embodiment of the present invention. The plurality of spacing materials can be woven or non-woven fibers 31. As shown in FIG. 3, each fiber 31 can be solid or hollow, and/or the surface of the fiber 31 can have at least a hole 32. When the non-woven fibers are used to make the porous lead-carbon material, the non-woven fibers can be densely distributed all over the surface of a lead plate, so that some of the fibers 31 can at least partially contact their neighboring fibers 31 and form an inter-connected structure. The inter-connected structure assists extension or progress of the pathways 23 during the production of the porous MMC 20, as shown in FIG. 2.

According to an embodiment of the present invention, the candidate for the plurality of spacing materials can be one of a porous material and a nonporous material. The porous material is one selected from a group consisting of a microporous material, a mesoporous material, a macroporous material and a nonporous material. The microporous material is one selected from a group consisting of a microporous activated carbon material, a carbon fiber material, an activated carbon fiber material, a carbon black material, a graphene material, a graphene oxide material, a carbon nanotube material, a zeolite material, a metal organic framework material. The mesoporous material is one selected from a group consisting of a mesoporous activated carbon material and a zeolite material. The macroporous material is one selected from a group consisting of a fiber, a macroporous zeolite, a macroporous mesh, a macroporous resin, and a macroporous silica. The nonporous material is a chemically inert material. The chemically inert material is one selected from a group consisting of a stainless metal material, a metal oxide material, and a PTFE material.

In comparison with the non-woven fibers, the fibers in the woven fibers are interwoven so that the woven fibers are also inter-connected. It can be realized that, when using the woven fibers to make the porous lead-carbon material, the passages are more easily formed than that using the non-woven fibers.

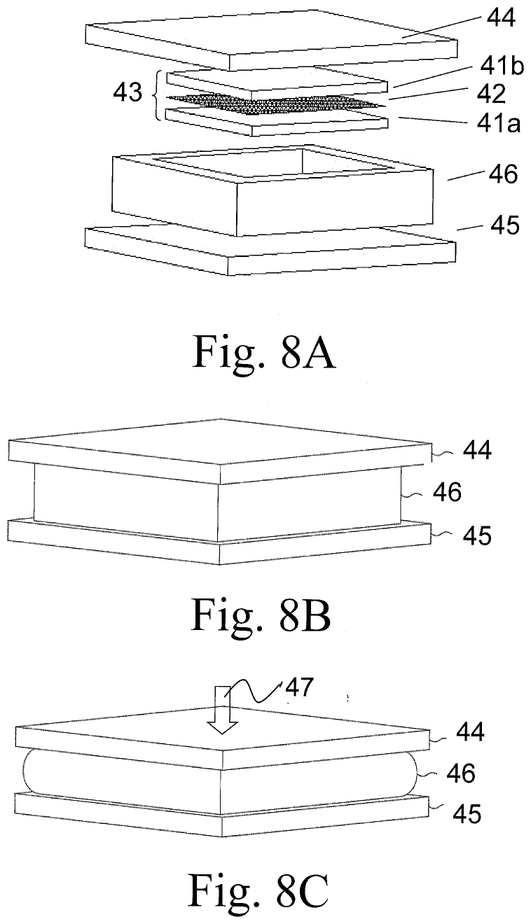

FIGS. 4-7 shows a flowchart of the methods for producing a porous MMC having a plurality of spacing materials embedded therein according to an embodiment of the present invention. FIGS. 8A-8C shows how the porous MMC is produced using a mold according to an embodiment of the present invention. In the case of producing a porous lead carbon composite having a lead-carbon interface, the metal material 41 is a lead plate, and the plurality of spacing materials 42 are carbon fibers.

As shown in FIGS. 4 and 8A, the steps include providing a metal material 41 (S41), providing a spacing material 42 forming an interconnected structure (S42), embedding the spacing material 42 in the metal material 41 to form an interface between the metal material 41 and the interconnected structure (S43), and forming a first plurality of pores located at the interface (S44).

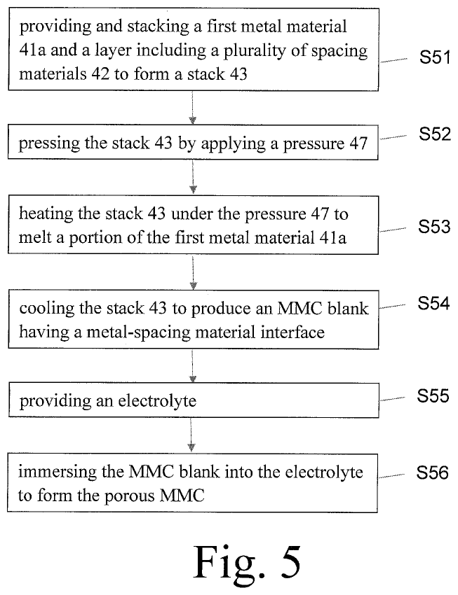

As shown in FIGS. 5 and 8A, the steps include providing and stacking a first metal material 41a and a layer including a plurality of the spacing materials 42 to form a stack 43 (S51), pressing the stack 43 by applying a pressure 47 (S52), heating the stack 43 under the pressure 47 to melt a portion of the first metal material 41a (S53), cooling the stack 43 to produce an MMC blank having a metal-spacing material interface (S54), providing an electrolyte (S55), and immersing the MMC blank into the electrolyte 5 to form the porous MMC (S56).

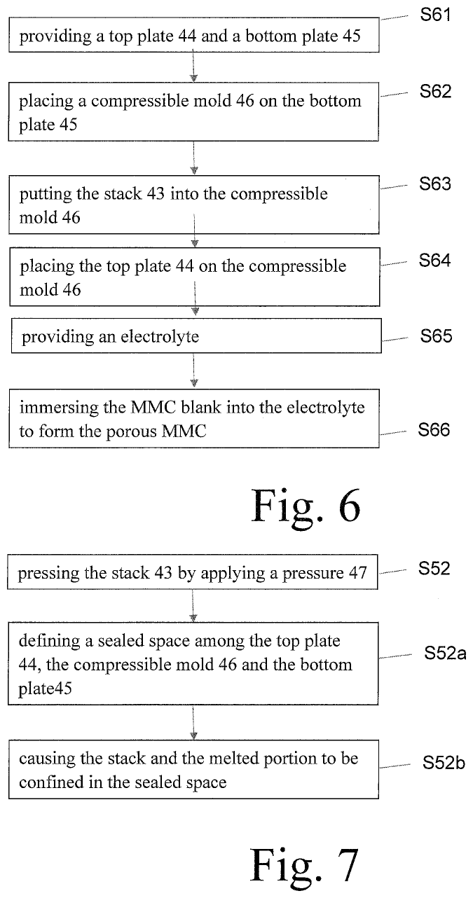

As shown in FIGS. 6 and 8A, the steps include providing a top plate 44 and a bottom plate 45 (S61), placing a compressible mold 46 on the bottom plate 45 (S62), putting the stack 43 into the compressible mold 46 (S63), placing the top plate 44 on the compressible mold 46 (S64), providing an electrolyte (S65), and immersing the MMC blank into the electrolyte to form the porous MMC (S66).

After the step S52 in FIG. 5, as shown in FIGS. 7 and 8B-8C, further steps include defining a sealed space among the top plate 44, the compressible mode 46 and the bottom plate 45 (S52a), and causing the stack 43 and the melted portion to be confined in the sealed space (S52b). In another embodiment of the present invention, the steps S52a and S52b are performed in one step.

In another embodiment of the present invention, a second metal plate 41b can be provided, and in this case, the layer of the spacing materials 42 are sandwiched between the first metal plate 41a and the second metal plate 41b to form the stack 43, as shown in FIG. 8A. Additional metal plates and layers of the spacing materials can be further stacked in the stack 43.

As shown in FIG. 8A, if the compressible mold 46 is open at both of its top and bottom, a top plate 44 is required to cover the compressible mold 46, and a bottom plate 45 is required to support the compressible mold 46. In this case, as shown in FIGS. 8A-8B, a top plate 44 and a bottom plate 45 are also provided. The compressible mold 46 is placed on the bottom plate 45. The stack 43 is put into the compressible mold. The top plate 44 is then put on the compressible mold 46. In another embodiment according to the present invention, the compressible mold 46 and the bottom plate 45 is integrally formed or connected into one piece.

As shown in FIG. 8C, the stack 43 is to be pressed under a pressure 47 by applying a force on the stack 43 through the top plate 44. During the pressing step, the top plate 44, the compressible mold 46 and the bottom plate 45 cooperatively encompass a space and define the space as an internal sealed space. Then heating the stack under the pressure 47 to melt a first portion of the first lead plate 41a and a second portion of the second lead plate 41b.

If the pressing step S52 and the heating step S53 in FIG. 4A overlap or occur at the same time, the steps of defining the sealed space, and causing the stack 43 and the melted first and second portions confined in the sealed space occur simultaneously. It means that the pressing step and the defining step can be performed in one step.

After the spacing materials 42 are pressed into the first metal material 41a and/or the second metal material 41b, a cooling step is performed and an MMC blank having a metal-spacing material interface, e.g. a lead carbon composite (LCC) blank having a lead-carbon interface in this case, is produced.

The MMC blank having the layer of plurality of spacing materials 42 embedded in the first metal material 41a and/or the second metal material 41b provides pores and the pathways for the electrolyte, such as sulfuric acid, to flow or penetrate into the MMC blank from its edges.

During the heating step S53 and cooling step S54 in FIG. 5, as shown in FIG. 8C, a heat transferred to and from the stack 43 is conducted through at least one of the top plate 44, the bottom plate 45 and the compressible mold 46; the pressure 47 for the pressing step S52 is one of a constant pressure and a predetermined pressure gradient; a heating temperature for the heating step S53 is one of a constant heating temperature and a predetermined heating temperature gradient; and a cooling temperature for the cooling step S54 is one of a constant cooling temperature and a predetermined cooling temperature gradient.

Expansion of Pores or Extension of Pathways in Porous Metal Matrix (MMC)

The MMC blank is then immersed into an electrolyte. The electrolyte can be one of H₂O and an aqueous solution of an acid, a base, or a salt thereof. The acid is one selected from H₂SO₄, HNO₃, HCl, HBr, HClO₃, H₂CO₃ and CH₃COOH, and the base is one selected from a group consisting of KOH and NH₄OH. The base is one of KOH and NH₄OH. A salt is a substance produced by the reaction of an acid with a base. A salt consists of the positive ion (cation) of a base and the negative ion (anion) of an acid. For example, the salt is, but is not limited to, one of NaCl, CaCl₂, NH₄Cl, CuSO₄, KBr, CuCl₂, NaCH₃COO, CaCO₃ and NaHCO₃.

Initial Activation Stage

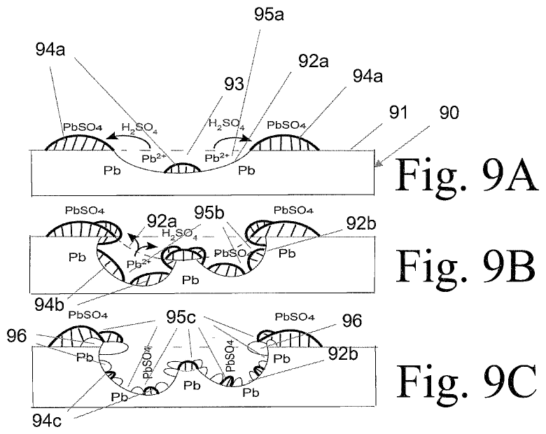

As shown in FIGS. 9A-9C, at the initial activation stage, the MMB blank is immersed in an electrolyte (not shown). In one embodiment according to the present invention, the metal material in the MMC blank is lead (Pb) and the electrolyte is H₂SO₄. As shown in FIG. 9A, when the MMC blank 90 is immersed in H₂SO₄, the grains 94a of PbSO₄, a salt formed from lead and sulfuric acid, are formed by a spontaneous chemical reaction of lead and sulfuric acid. It is because, in sulfuric acid solution, lead atoms in lead are dissociated into Pb²⁺ ions and the ions react with sulfuric acid to form the grains 94a of PbSO₄ at any surface, such as at the surface 91 of the lead plate and/or at the inner surface 92a at the periphery of the pore 93 in the MMC blank 90. During the reaction occurs, the number of the grains 94a increases with time, so that some first pores/passages/pathways 95a start to form between the grains 94a of PbSO₄ progressively.

First Discharging Stage

The MMC blank treated after the initial activation stage serves as an electrode, and a counter electrode is prepared. In a preferred embodiment according to the present invention, two MMC blanks (hereinafter called Blank A and Blank B) are immersed in an electrolyte, such as H₂SO₄, and serve as an anode and a cathode respectively. Similar to the operation of a lead acid battery, at the first discharging stage, a first voltage is applied to the anode and the cathode, Blank A serves as the anode, and Blank B serves as the cathode. The lead at the surface 91 or the lead at the inner surfaces 92a of Blank A is oxidized to form lead ions (Pb²⁺ ), and the lead ions react with sulfate ions dissociated from the sulfuric acid (H₂SO₄) to newly form additional grains 94b of PbSO₄ at the surface or at the inner surfaces 92b that is further eroded from the inner surface 92a in the Blank A. It should be noted that, the size of the grains 94b newly formed at the first discharging stage is usually smaller than those of the grains 94a formed at the initial activation stage. It means that a lot of second pores/passages/pathways 95b are further formed between the grains 94b at the first discharging stage. The size of the second pores 95b is smaller than the pores 95a. In the meantime, the grains of the lead sulfate formed on the surfaces of the Blank B (not shown) serving as the cathode will dissociate into lead ions and sulfate ions, the lead ions dissociated from Blank B are reduced into lead to form at the surfaces or at the inner surfaces 92b in Blank B, and the sulfate ions are reduced to form sulfuric acid. The reduction-oxidation (redox) reaction occurs at the anode and the cathode results from an electro-chemical reaction during the first discharging process.

First Charging Stage

At the first charging stage, Blank B serves as the anode, and Blank A serves as the cathode now. A second voltage is applied to the anode and the cathode. The lead at the surface or at the inner surfaces of the pores in Blank B is oxidized to form lead ions, and the lead ions react with sulfate ions to form additional grains of lead sulfate at the surface or at the inner surfaces of Blank B. If the applied voltage is high enough, some gases such as hydrogen and/or oxygen are generated because of hydrolysis of water in the sulfuric acid solution. The generated gases are capable of expanding the spaces in the passages or pathways. In the meantime, Blank A serves as a cathode. As shown in FIG. 9C, some of the grains 94b formed on Blank A will dissociate to form lead ions, and the lead ions are reduced to lead 96 and formed at the surface or at the inner surfaces 92b of Blank A. It should be noted that, the grain size of the reduced lead 96 formed at the first charging stage is usually smaller than those of the grains 94a of lead sulfate formed at the initial activation stage. Accordingly, in Blanks A and B, expansion of the pores (including and/or extension of pathways are achieved. At present, a porous MMC, which is a lead carbon composite (LCC) in an embodiment according to the present invention, is formed.

It is noted that, the reduction-oxidation (redox) reactions occurring at the first discharging stage and the first charging stage constitute one redox cycle. More redox cycles can be performed to obtain finer grains of the lead sulfate and finer grains of the reduced lead growing at Blanks A and B.

After experiencing the initiate stage, the first discharging stage, and a second discharging stage, some of the pores and passages (which form an erosion region) are formed at the positions (or the contact surfaces) that the lead material contacts the embedded plurality of the spacing materials. At the charging stage, the gasses (bubbles) of hydrogen and oxygen are formed to further erode the porous lead plate to form the erosion region.

If Blanks A and B are installed in a lead-acid battery, when the battery is operating in a vehicle, through continuing discharging and charging processes, the grains of the lead sulfate and the reduced lead will keep growing, and the size of each of the grains of the lead sulfate and the reduced lead will become smaller and smaller.

It should be also noted that, it is feasible to select any combination of the metal material and the electrolyte having the redox reaction similar to lead and sulfuric acid according to the present invention.

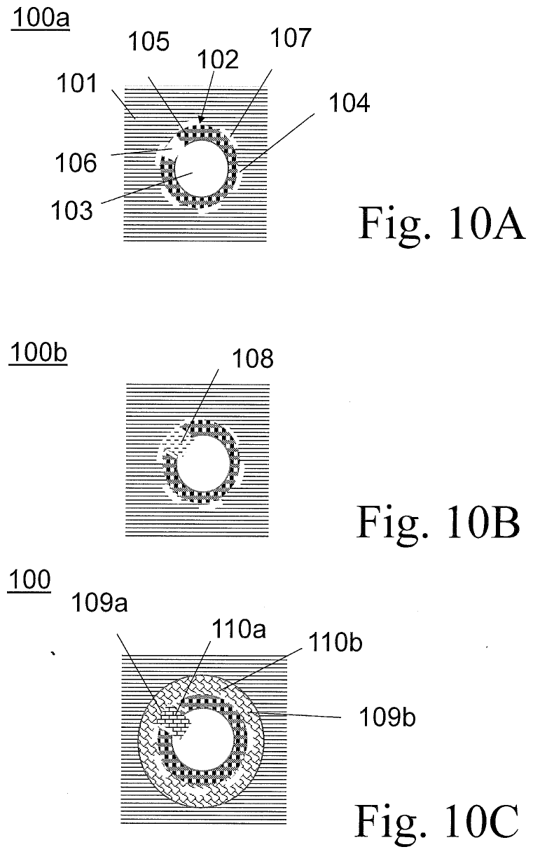

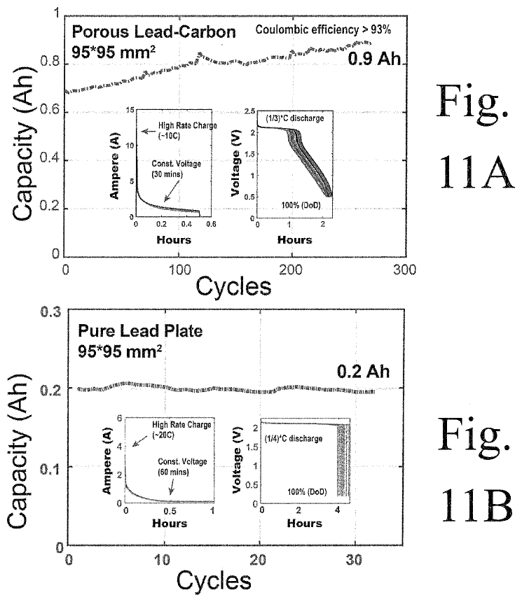

FIGS. 10A-10C each shows a cross-section of a piece of an MMC blank 100, and the semi-products 100a and 100b, with a tubular carbon fiber 102 having a hollow core 103 embedded in a lead material 101 at different stages. As shown in FIG. 10A, it describes again how the pores generate the diffusion pathways 104 in a semi-MMC blank 100a. In the semi-MMC blank 100a, there are the lead material 101 in the semi-MMC blank 100a, and a segment of a tubular carbon fiber 102 including the circle section 105 with an opening 106 at one side in the radial direction. When the semi-MMC blank 100a is made, there are some gaps 107 and pathways 104 existing between the lead material 101 and the segment of the carbon fibers 102. In the heating step S53, as shown in FIG. 5, a part of the lead material 101 near the opening 106 also melts during the pressing step S52 and the heating step S53, goes into the opening 106 of the carbon fiber 102, and is solidified to form the solidified lead 109a during the cooling step S54, as the semi-MMC blank 100b shown in FIG. 10B.

During the discharging stages, as shown in FIG. 10C, some passages 109b and 110b are further formed between the grains 109a and between the grains 110a. Because the size of the grains 109a and 110a of the lead sulfate is larger than the reduced lead, when the grains 109a and 110a are newly formed, they will expand to squeeze the lead material 101, and create more gaps between the lead material 101 and the carbon fibers 102 in the semi-MMC blank 100b to obtain the MMC blank 100. The region that the grains expand the pores to create larger gaps is called an expansion region. The more the discharging processes are performed, the larger the expansion regions will be formed.

FIG. 11A-11B shows two diagrams showing capacitance (i.e., capacity to hold charge) curves of different electrodes of 95*95 mm² size of respective porous lead plate according to the present invention (please refer to FIG. 11A) and the pure lead plate (please refer to FIG. 11B) during several charging and discharging cycles. As shown in FIG. 11A, when the electrode using the porous lead plate was tested for 300 cycles with the high charging rate of 10 C at constant voltage for 30 minutes and with the discharging rate of (1/3) C for 2 hours, and the depth of discharge is 100%, it can be found that the capacitance effect gradually increased from about 0.7 Ah to 0.9 Ah. That is to say, during the charging and discharging cycles, the pores generated along the pathways at the lead-carbon interface dramatically increased. In comparison, as shown in FIG. 11B, when the electrode using the pure lead plate was tested for 30 cycles with the high charging rate of 20 C for one hour and with the discharging rage of (1/4) C for 4 hours, and the depth of discharging is 100%, the capacities maintain almost the same at 0.2 Ah with the increase of the cycles from 0 to 30. In other words, the capacitance of the electrode using the porous lead plate was almost 4.5 times growth of that using the pure lead plate. In addition, it can be explained that the surface area of the pores in the porous lead plate that participated in the charging and discharging processes gradually increased, and the phenomenon of increase of the capacitance effect appeared. Accordingly, the surface area of the pores and generated along the pathways at the lead-carbon interface in the electrode using the porous lead plate improves the performance as well as the lifetime of the acid battery.

Method for Forming an Electrode

A method for producing an electrode for a lead acid battery comprises the following steps: providing a metal material and a spacing material containing carbon; embedding the spacing material in the metal material to obtain a carbon-metal material; and immersing the carbon-metal material in a bath having an acid to form the electrode.

Method for Forming an Electrode for a Lead Acid Battery

An electrode for a lead acid battery comprise a metal material and a spacing material containing carbon and having an inter-connected structure with a surface. The spacing material is embedded in the metal material. The electrode further comprises a plurality of pores including a first pore and a second pore and disposed on at least a part of the surface. The electrode further comprises an additional plurality of pores disposed between the first pore and the second pore. The electrode further comprises a second layer of a plurality of carbon fibers embedded in the metal material, the first layers and the second layers of the plurality of carbon fibers have a same orientation or a different orientation. The inter-connected structure is one selected from a group consisting of 1-D, 2-D and 3-D structures.

Advantages of the Present Invention

The present invention discloses the porous metal matrix composite such as a porous lead-carbon composite having a high capacitance, a high coulomb efficiency, a high depth of discharge, and a long life-time resulting from the continuous formation of the passages for the grains of lead sulfate during the discharging and charging processes, and has the effect of a super capacitor.

The various embodiments according to the present invention described above and various changes or modifications thereof belong to the scopes of the method for forming a lead-carbon interface layer on a lead-based substrate, and the acid battery having the lead-carbon interface layer provided by the present invention. The advantages achieved by the method for forming a lead-carbon interface layer on a lead-based substrate, and the acid battery having the lead-carbon interface layer provided by the present invention include a significant improvement in the life time and the capacitance of the acid battery. In addition, because it is not necessary to use noble metal such as titanium, palladium and platinum, the cost of producing the lead-carbon interface layer is significantly lower than that of electrodes manufactured using prior techniques. Therefore, the present invention can surely be widely used in the practical applications of batteries.

While the present disclosure has been described in terms of what is presently considered to be the most practical and preferred embodiments, it is to be understood that the present disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for producing a porous metal matrix composite (MMC), comprising the following steps:
providing and stacking a first metal material and a layer including a plurality of spacing materials to form a stack;
pressing the stack by applying a pressure;
heating the stack under the pressure to melt a portion of the first metal material;
cooling the stack to produce an MMC blank having a metal-spacing material interface;
providing an electrolyte; and
immersing the MMC blank into the electrolyte to form the porous MMC.

2. The method according to claim 1, where in the pressing step further comprises the steps of:
providing a top plate and a bottom plate;
placing a compressible mold on the bottom plate;
putting the stack into the compressible mold; and
placing the top plate on the compressible mold.

3. The method according to claim 2, wherein the pressing step further comprises a step of defining a sealed space among the top plate, the compressible mold and the bottom plate.

4. The method according to claim 3, further comprising a step of causing the stack and the melted portion to be confined in the sealed space.

5. The method according to claim 4, wherein the defining step and the causing step are performed in one step.

6. The method according to claim 1, wherein the pressing step comprises the sub-steps of:
providing a second metal material; and
disposing the layer between the first metal material and the second metal material to form a sandwich structure; and
the melting step further includes melting a second portion of the second metal material.

7. The method according to claim 1, wherein the electrolyte is one of H₂O and an aqueous solution of an acid, a base, and a salt thereof

8. The method according to claim 7, wherein the acid is one selected from a group consisting of H₂SO₄, HNO₃, HCl, HBr, HClO₃, H₂CO₃ and CH₃COOH, and the base is one selected from a group consisting of KOH and NH₄OH.

9. The method according to claim 1, wherein the layer of the plurality of spacing material includes one of a porous material and a nonporous material.

10. The method according to claim 9, wherein the porous material is one selected from a group consisting of a microporous material, a mesoporous material and a macroporous material.

11. The method according to claim 10, wherein the microporous material is one selected from a group consisting of a microporous activated carbon material, a carbon fiber material, an activated carbon fiber material, a carbon black material, a graphene material, a graphene oxide material, a carbon nanotube material, a zeolite material and a metal organic framework material.

12. The method according to claim 10, wherein the mesoporous material is one selected from a group consisting of a mesoporous activated carbon material and a zeolite material.

13. The method according to claim 10, wherein the macroporous material is one selected from a group consisting of a fiber, a macroporous zeolite, a macroporous mesh, a macroporous resin, and a macroporous silica.

14. The method according to claim 9, wherein the nonporous materials is a chemically inert material.

15. The method according to claim 14, wherein the chemically inert material is one selected from a group consisting of a stainless metal material, a metal oxide material, and a PTFE material.

16. The method according to claim 6, wherein each of the first metal material and the second metal material is a lead.

17. A method for producing a porous metal matrix composite (MMC), comprising steps of:
providing a metal material;
providing a spacing material forming an interconnected structure;
embedding the spacing material in the metal material to form an interface between the metal material and the interconnected structure; and
forming a first plurality of pores located at the interface.

18. A porous metal matrix composite (MMC), comprising:
a metal material;
a spacing material forming an interconnected structure and embedded in the metal material to form an interface between the metal material and the interconnected structure; and
a first plurality of pores located at the interface.

19. The porous MMC according to claim 18, further comprising a first salt formed on the metal material and disposed in one of the first plurality of pores.

20. The porous MMC according to claim 18, further comprising a second plurality of pores disposed on the metal material and in one of the first plurality of pores.
